(19) United States
(12) Patent Application Publication
(10) Pub. No.: US 2013/0022318 A1
(43) Pub. Date: Jan. 24, 2013

(54) FIELD TERMINATED FIBER OPTIC AND ELECTRICAL CONNECTION DEVICE

(71) Applicants: Laurence Henry Fingler, King City (CA); William Alexander Slater, Tottenham (CA); Dennis Keith McCormick, Keswick (CA)

(72) Inventors: Laurence Henry Fingler, King City (CA); William Alexander Slater, Tottenham (CA); Dennis Keith McCormick, Keswick (CA)

(73) Assignee: Fiber Connections Inc., Schomberg (CA)

(21) Appl. No.: 13/551,952

(22) Filed: Jul. 18, 2012

(30) Foreign Application Priority Data
Jul. 18, 2011 (CA) 2746773

(51) Int. Cl. G02B 6/36

(52) U.S. Cl. 385/78; 385/77

(57) ABSTRACT

A modified communication cable and terminal connector provides an effective combination to accommodate the transmission of signals over fiber optic conductors. The terminal connector includes a light transmitter, a light receiver and interface circuitry such that the connector exchanges signals over electrical conductors. The connector receives and engages fiber optic conductors and an alignment ferrule completes a connection with a fixed lens of the transmitter or receiver. The particular arrangement requires cleaving of the fiber optic conductors but avoids steps such as polishing and gluing.

### FIELD OF THE INVENTION

The present application relates to fiber optic cables and in particular to a terminal connector for such cables.

### BACKGROUND OF THE INVENTION

There are many terminal connectors for conventional communication cables that utilize metal or copper conductors. These conductors are easily stripped by the end user and the bare conductor can then be appropriately electrically connected to a terminal connector.

Connecting a terminal connector to a fiber optic cable is more difficult and is typically completed in a factory environment. Field termination of optical conductors is challenging and requires stripping of the jacket and cladding, careful handling of a fragile bare optic fiber, positioning, gluing, polishing and finally crimping of ferrules and assembly in a connector.

It is well accepted that termination of fiber optic cables is difficult and for many commercial applications predetermined lengths of fiber optic cable are ordered where each end of the fiber optic cable includes its own optical terminal connector that was installed under factory conditions. This approach for terminating of fiber optic cables is certainly advantageous in that the actual fiber optic connection will be of a high quality. Unfortunately this solution requires ordering of cables of specific lengths and for new installations it is common practice to estimate the length of a cable and order a terminated cable which is of a greater length to hopefully accommodate variations that occur during installation. Furthermore, with fiber optic cables which have already been terminated, these cables are more difficult to pull through conduits etc. and some cables may be damaged during installation. It would be advantageous to install fiber optic cables without terminal connectors on either end thereof and merely cut the cable at the appropriate length once it has been installed. Terminal connectors would then be installed at either end of the communication cable. With such an arrangement the actual drawing of the cable or installing of the cable is simplified, however field installable terminal connectors are necessary. As outlined above, the installation of connectors for fiber optic cables is more difficult relative to pure electrical conductors and field installation of such terminal connectors is typically avoided.

For some communication applications the communication cable includes a combination of fiber optic conductors as well as conventional copper conductors to provide low voltage power (typically 58 volts DC or less). These conductors can provide 48 volts for normal Power over Ethernet (PoE) applications or higher voltages (58 volts) for PoE at higher power levels.

One of the significant difficulties with respect to fiber optic connectors is due to signal loss at a splice or connection point. Part of the signal loss is purely a result of the interruption in the conductor and a further portion of the signal loss is due to the quality of the connection. Field installation of fiber optic connections remains a significant challenge.

A terminal connector for a communication cable having fiber optic conductors is proposed in the present invention that operates in a different manner and provides an effective system that allows field installation of terminal connectors when required. The terminal connector utilizes a simplified integration of the fiber optic connector with a light transmitter (typically a LED transmitter) or other with a light receiver (typically a photodiode receiver). The LED transmitter and the photodiode receiver are incorporated in the terminal connector such that the terminal connector receives and transmits electrical signals.

In a preferred embodiment the fiber optic communication cable also includes electrical power conductors for powering of active equipment. Power is extracted for powering a circuit board and powering of the LED transmitter and photodiode of the terminal connector. These electrical power conductors are also electrically connected within the terminal connector. In a preferred embodiment the terminal connector includes nine electrical conducting pins for connecting to other equipment. Two of these pins provide low voltage power and seven pins are associated with received and transmitted light signals and the processing thereof by the interface circuitry, the LED transmitter and the photodiode receiver. Depending upon the circuitry, the LED and the photodiode less or more conductors may be present.

With the terminal connector a simplified approach for terminating fiber optic conductors includes the use of the LED transmitter and the photodiode receiver within the terminal connector. The terminal connector uses electrical signals for communicating with active devices in communication therewith by the terminal connector.

The present application also discloses a simplified termination process for installing a terminal connector on a communication cable having fiber optic conductors. The communication cable is prepared at the end thereof to strip a portion of the conductor to expose the bare fiber conductors, insert the fiber conductors into a device to carry out a cleaving step and inserting of the prepared fibers into a LED transmitter or a photodiode receiver that are each secured within the terminal connector.

In the case where the communication cable includes electrical power conductors, the electrical conductors are also stripped at the end, cut to the appropriate lengths and secured to electrical terminals within the terminal connector. The terminal connector effectively receives an electrical communication signal and converts it to an optical signal using the LED transmitter and the terminal connector effectively receives an optical signal via the photodiode and converts that optical signal to an electrical communication signal. Electrical signals are provided to the terminal connector and electrical signals are provided by the terminal connector to active components. In this way the actual interface between the terminal connector and the associated device is an electrical connection and the appropriate light processing occurs in the terminal connector to receive optical signals and convert the same to an electrical signal, and to receive an electrical signal and convert it to an optical signal transmitted on one of the fiber connectors using the LED transmitter.

The provision of a photodiode receiver and an LED transmitter within the actual terminal connector significantly simplifies the termination of the fiber optic conductors as each of these devices is more tolerant and signal loss is no longer critical. Basically the termination point of these fiber optic conductors is within the transmitting or the receiving device and thus the signal quality is good. The actual preparation of the fiber optic cable and the receipt within these devices is also simplified and suitable for end user installation.

### SUMMARY OF THE INVENTION

A terminal connector for a communication cable having fiber optic conductors according to the present invention comprises a terminal body housing, a photodiode having a guide channel receiving a fiber optic conductor in communication with the photodiode, an LED transmitter having a guide channel receiving a fiber optic conductor in communication with the LED transmitter, and a circuit board and power connection for the circuit board. The circuit board is connected to electrical conductors for receiving or transmitting electrical signals, and receives an electrical signal and uses the LED transmitter to transmit the received electrical signal as a light signal on the fiber optic conductor in communication with the LED transmitter. The photodiode receives a transmitted light signal on the fiber optic conductor in communication therewith and converts the signal to an electrical signal provided to the circuit board that based thereon transmits an electrical signal on one of the electrical conductors.

In an aspect of the invention, the communication cable includes two electrical power conductors and the terminal connector includes two electrical terminals on the circuit board for forming an electrical connection therewith in the terminal body. The circuit board includes two external electrical connectors electrically connected to the electrical terminals via the circuit board for connecting with other signal processing equipment.

In an aspect of the invention, both the LED transmitter and the photodiode include a communication guide channel for receiving a short length of a stripped fiber optic conductor within the terminal body.

In a preferred aspect of the invention, each guide channel receives a jacketed fiber optic conductor between one of the LED transmitter and the photodiode.

According to an aspect of the invention, the communication cable includes two electrical conductors and two fiber optic conductors all connected to separate external electrical conductors of the terminal connector provided thereon in a manner for collective connection with external equipment.

In an aspect of the invention, power is provided to the circuit board through the terminal connector.

In a preferred structure of the invention, the LED transmitter and the photodiode each include a fiber alignment ferrule receiving a bare cleaved fiber conductor.

In yet a further aspect of the invention, the terminal connector includes an engaging cavity for each alignment ferrule that secures the alignment ferrule relative to one of the LED transmitter and the photodiode.

### BRIEF DESCRIPTION OF THE DRAWINGS

Preferred embodiments of the invention are shown in the drawings, wherein:

FIG. 1 is a partial perspective view showing a communication cable having two electrical conductors and two fiber optic conductors with the ends thereof prepared for insertion within the terminal connector;

FIG. 2 is a partial perspective view of a fiber cleaving device for preparing of the ends of the fiber optic cables;

FIG. 3 is a partial perspective view showing the communication cable and the connection thereof in components of the terminal connector;

FIG. 4 is a cross sectional view showing the connection of a fiber optic cable to a photodiode receiver;

FIG. 5 is a partial perspective view of the communication cable having various conductors connected within the body of the terminal;

FIG. 6 is a partial perspective view showing the terminal connector with a cover piece effectively closing the body portion of the terminal;

FIG. 7 is a partial perspective view showing the fiber optic cable with the terminal connector secured thereon with the terminal connector in engagement with an active device;

FIG. 8 is a partial perspective view of a completed communication cable and terminal connector;

FIG. 9 is a perspective view of a media converter device as modified for use with the terminal connector; and

FIG. 10 is a perspective view of the media converter with a received terminal connector.

### DETAILED DESCRIPTION OF THE PREFERRED EMBODIMENTS

A completed terminal connector is shown as 30 in FIG. 6 secured at one end of the fiber optic communication cable 2. In the embodiment shown the fiber optic communication cable 2 includes two low voltage electrical power conductors 4 and 5 as shown in FIG. 1 and two fiber optic conductors shown as 6 and 7. Additional conductors could be provided. The electrical conductors 4 and 5 are of the traditional type and as shown in FIG. 1 these conductors 4 and 5 have been stripped and bare conductors 4a and 5a are exposed. These conductors provide low voltage power typically less than 58 volts for some PoE applications. For some PoE applications 48 volts is sufficient.

The fiber optic communication cable 2 as shown in FIG. 1 additionally includes fiber optic conductors 6 and 7 that have also been prepared for connection to the terminal connector 30 as a jacket 10 in combination with a sheath 12 have been removed to expose the glass fiber conductors 14 and 16.

A cleaving device 20 as shown in FIG. 2 is used to cleave the ends of the glass fiber conductors 14 and 16 in an accurate manner and to produce a desired length of the conductors and an acceptable light transmitting end. These cleaved ends are located in front of and aligned with a lens of an LED transmitter or a photodiode receiver as will be subsequently discussed.

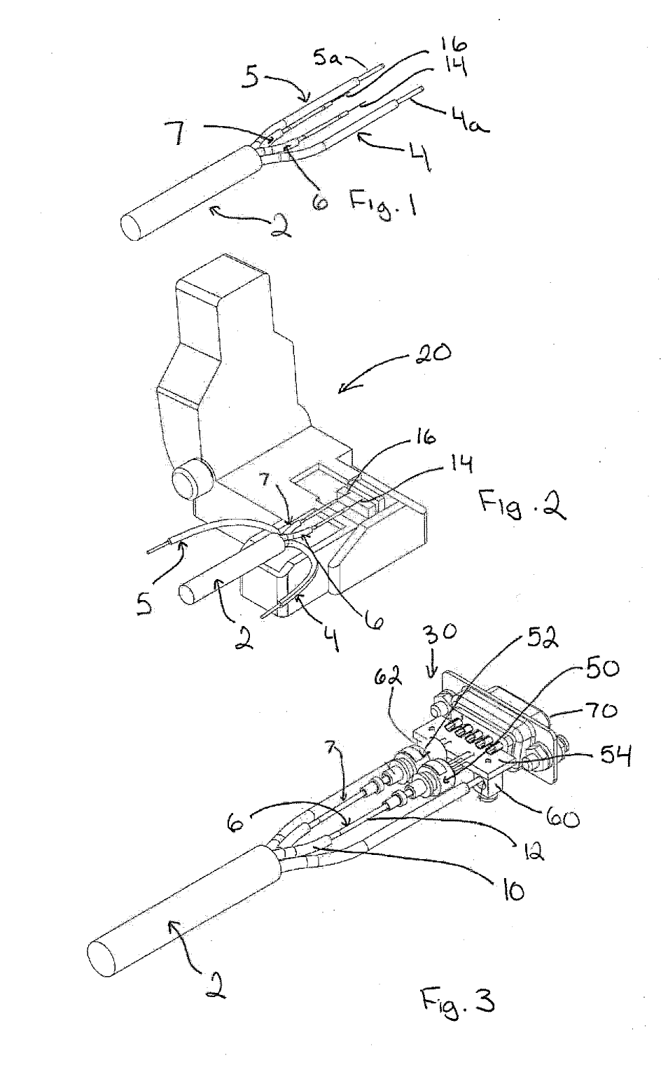

The fiber optic communication cable 2 is shown in FIG. 3 connected to the operating components of the terminal connector 30. The traditional copper conductors 4 and 5 are shown connected to the circuit board 54 using electrical terminals 30. The circuit board 54 provides a simple means to connect these electrical conductors to electrical conductors provided as part of the electrical mechanical connecting portion 70. The circuit board 54 is also connected to the photodiode receiver 50 and the LED transmitter 52. The photodiode receiver 50 receives a signal from the fiber optic conductor 6 and the photodiode receiver/circuit board effectively converts a received light signal into an electrical signal which is provided as part of the electrical mechanical connecting portion 70. The electrical mechanical connecting portion 70 also includes an electrical connection which feeds an electrical signal to the LED transmitter 52 via the circuit board 54. The LED effectively reproduces the signal as a light signal and transmits it over the fiber optic conductor 7.

The circuit board 54 includes interface circuits for signal processing associated with the LED transmitter and photodiode receiver. Depending upon the particular application some buffering circuits will be needed.

As can be appreciated from a review of FIG. 3, the fiber optic cable having two electrical conductors 4 and 5 and two fiber optic conductors 6 and 7 now cooperate with the terminal connector 30 that via the electrical mechanical connecting portion 70 provides electrical signals to or receives electrical signals from active equipment or components. Electrical signals are received by the terminal connector and one of these signals is converted to a light signal via the LED transmitter. Similarly the terminal connector receives the light signal from the fiber optic communication cable 2 and converts this signal to an electrical signal via the photodiode receiver 50. The electrical conductors 6 and 7 provide power for active equipment connected by the terminal connector 30 and additionally provide power for the circuit board 54 and interface circuits for the operation of the LED transmitter and the photodiode receiver 50.

With the present terminal connector 30 it is still required to make a suitable light transmitting connection with the photodiode receiver 50 and with the LED transmitter 52 as will be subsequently described.

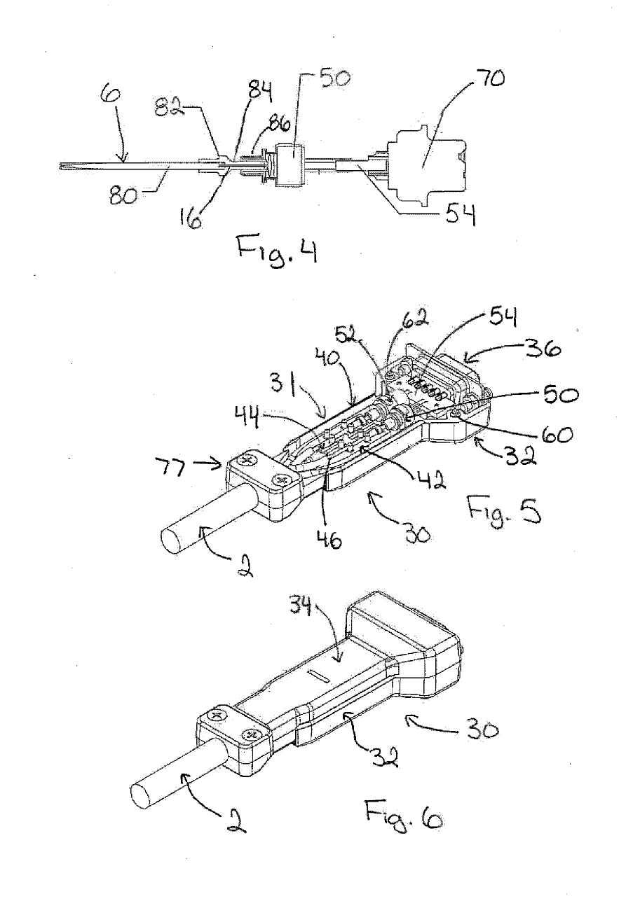

FIG. 4 shows the connection of a fiber optic conductor with the photodiode receiver 50. The fiber optic conductor 6 is shown with the cladding 80 received in one end of a fiber alignment ferrule 82. The fiber alignment ferrule 82 includes a nose portion 84 that receives the bare fiber conductor 16 that has been appropriately cut to length by cleaving. The fiber alignment ferrule with the fiber optic conductor inserted therein is then received within the receiving portion 86 of the photodiode receiver 50. With this arrangement a light signal provided on the fiber optic conductor is received by the photodiode and is converted to an electrical signal either in the photodiode receiver or as part of the circuit board 54. The circuit board 54 then provides the appropriate electrical connection to a conductor located within the electrical mechanical connecting portion 70.

The cleaved fiber optic conductors are arranged in front of and aligned with an internal lens of the photodiode or LED transmitter without making contact therewith. Polishing is not required as would be the norm in other applications. Gluing is not required as the body of the terminal connector clamps and holds the fiber conductor in position.

The time consuming steps of gluing and curing the fiber into a ferrule and/or polishing of the end face are avoided.

With the above arrangement the actual optical connection between the fiber optic connector and the photodiode receiver or the LED transmitter is greatly simplified and a good signal results as the bared conductor is provided within the alignment ferrule and accurately positioned relative to the photodiode receiver or the LED transmitter. The alignment ferrule also protects the somewhat fragile bared fiber conductor. There is no requirement to provide splicing on one fiber optic conductor to a second fiber optic conductor. The actual signals passed between the electrical mechanical connecting portion 70 and the associated active equipment or components are by electrical connections as opposed to electrical and fiber optic connections.

The terminal connector 30 as shown in FIGS. 4 and 5 includes an elongate portion 31 that is adapted to receive the various conductors and to also receive the photodiode receiver, the LED transmitter, the circuit board and the other components. The elongate portion 31 is also configured to provide a suitable guide arrangement on opposite sides thereof for the electrical power conductors 4 and 5. Two outer guides 40 and 42 are shown for these electrical conductors. Two inner guides 44 and 46 are shown for the fiber optic conductors and the alignment with the photodiode receiver 50 and the LED transmitter 52. As shown in FIG. 4 the fiber optic conductors have had their alignment ferrules inserted into the respective photodiode receiver and LED transmitter. At an end of the terminal connector 30 opposite the electrical mechanical connecting portion 70 is a cable restraint portion 77 which effectively clamps the sheathed fiber optic communication cable. The outer portions of the fiber optic cable are removed and the conductors are prepared as discussed in the earlier figures.

Once the various conductors have been connected to the appropriate components of the circuit board, the terminal body 32 is releasably closed by the terminal cover 34. Suitable positive snap restraint or other locking arrangements can be used to maintain a completed housing about the various components. The terminal cover is typically removable to allow access to the various conductors, for example if problems occur in initially installing the terminal connector.

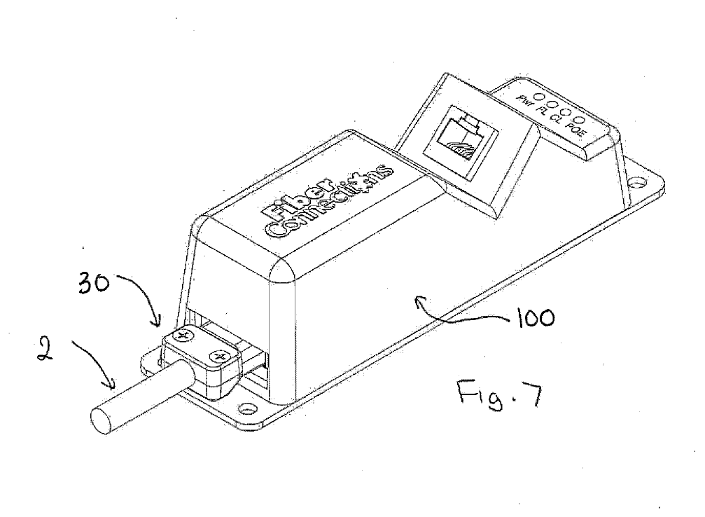

FIG. 7 shows the fiber optic communication cable 2 with the terminal connector 30 secured thereon and in electrical communication with the active equipment component 100.

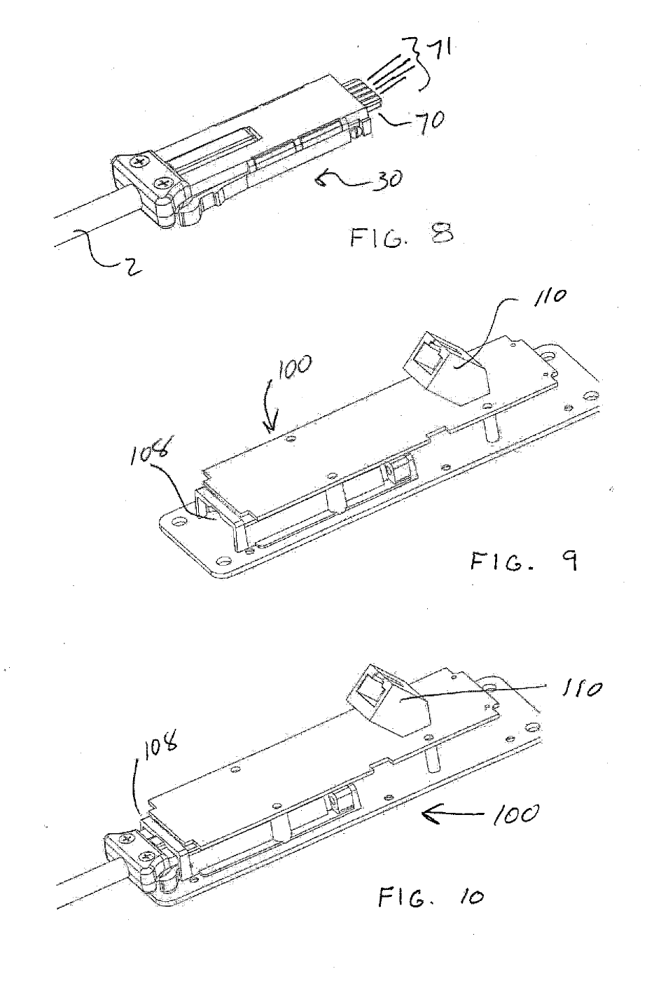

In FIG. 8 a fiber optic cable 2 has the terminal connector 30 secured thereon at one end of the cable. As can be seen the connecting portion 70 includes a series of conductors shown as 71. The fiber optic communication cable 2 as shown in FIG. 8 most commonly would only have fiber optic conductors, however this modified cable also includes electrical conductors as previously discussed. In order to provide a satisfactory light output from the cable any fiber optic connector previously would have been factory installed or would have undergone a very significant field installation procedure which is avoided with the terminal connector 30.

In light of the different operating parameters of the system as discussed in the present application the media converter 100 has also been modified. This media converter previously would have included both a photodiode receiver and an LED transmitter for communication of light signals. These components have now been shifted to the terminal connector 30 and the media converter 100 now includes four electrical conductors for suitable communication with the conductor 71 of the terminal connector 30. Additional electrical conductors would be provided if the communication cable 2 includes additional electrical and/or fiber optic connectors. In the present embodiment the connector has nine conductors, two for power, and seven for controlling the LED transmitter and photodiode and interface circuitry as well as signal transmission.

As shown in FIG. 10 the connecting portion 70 of the terminal connector 30 has now been coupled with the female connector 108 of the terminal connector and both a fiber optic communication path as well as an electrical power arrangement has now been completed due to the terminal connector 30 and specialized communication cable 2. Any further equipment can be connected via the Ethernet terminal generally shown as 110.

As can be appreciated several advantages are realized with the system disclosed herein. The cost of the overall system is similar to the previous arrangement where the media converter or other active equipment would include a suitable arrangement for processing of light signals and receiving electrical power. In contrast to these prior art arrangements, with the present system, fiber optic cable, preferably the modified fiber optic cable, is suitably pulled through any conduits or power trays etc. and cut to length on the job site. Once generally installed, the terminal connectors 30 can then be added to the communication cable by completing a field installation. This process is greatly simplified in that the fiber optic conductors are placed in communication with a lens of a photodiode receiver or the lens of a LED transmitter in the terminal connector. This system is also preferred in that the terminal connectors are not on the cable when the cable is being pulled through conduits etc. and problems that occur with other systems such as damage of the factory installed connectors when pulled through conduits is avoided.

Power is provided over the modified power and fiber optic communication cable through conductors 4 and 5. Communication light signals are transmitted over conductors 6 and 7. Electrical communication signals are provided to the active equipment through the conductors 71 of the terminal connector 30. The structure of this terminal connector and light processing or generating within the terminal connector, simplifies field installation of the terminal connector.

The light process or light generation within the terminal connector also simplifies the active components and simplifies connection therewith as electrical signals are exchanged.

The method of installing the modified or hybrid communication cable 2 and field installation of terminal connectors is cost effective, convenient and reliable. Initial field installation and/or repair has a number of advantages over previous accepted fiber optic light signal interconnection approaches and methodology.

The terminal connector has been described with respect to the preferred communication cable having two electrical conductors and two fiber optic conductors as this arrangement has many applications. More electrical or more fiber optic conductors can advantageously use this approach of the converting terminal connector and as such are part of the present invention.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A terminal connector for a communication cable having fiber optic conductors, said terminal connector comprising
a terminal body housing,
a photodiode having a guide channel receiving a fiber optic conductor in communication with said photodiode,
an LED transmitter having a guide channel receiving a fiber optic conductor in communication with said LED transmitter,
a circuit board and power connection for said circuit board, said circuit board being connected to electrical conductors for receiving or transmitting electrical signals;
said circuit board receiving an electrical signal and using said LED transmitter to transmit said received electrical signal as a light signal on said fiber optic conductor in communication with said LED transmitter;
said photodiode receiving a transmitted light signal on said fiber optic conductor in communication therewith and converting the signal to an electrical signal provided to said circuit board that based thereon transmits an electrical signal on one of said electrical conductors.

2. A terminal connector for as claimed in claim 1 wherein said communication cable includes two electrical power conductors and said terminal connector includes two electrical terminals associated with said circuit board for forming an electrical connection therewith in said terminal body, said circuit board including two external electrical connectors electrically connected to said electrical terminals via said circuit board for connecting with other signal processing equipment.

3. A terminal connector as claimed in claim 1 wherein both said LED transmitter and said photodiode include a communication guide channel for receiving a short length of a stripped fiber optic conductor.

4. A terminal connector as claimed in claim 2 wherein both said LED transmitter and said photodiode include a communication guide channel for receiving a short length of a stripped fiber optic conductor.

5. A terminal connector as claimed in claim 3 wherein each guide channel receives jacketed fiber optic conductor between one of said LED transmitter and said photodiode.

6. A terminal connector as claimed in claim 4 wherein each guide channel receives jacketed fiber optic conductor between one of said LED transmitter and said photodiode.

7. A terminal connector as claimed in claim 1 wherein said communication cable includes two electrical conductors and two fiber optic conductors all connected to separate electrical conductors of said terminal connector provided thereon in a manner for connection with external equipment.

8. A terminal connector as claimed in claim 7 wherein said fiber optic cable and the electrical power conductors thereof are together connected to external equipment by connection of said terminal connector.

9. A terminal connector as claimed in claim 8 wherein power is provided to said circuit board through said terminal connector.

10. A terminal connector as claimed in claim 1 wherein said LED transmitter and said photodiode each include a fiber alignment ferrule receiving a bare cleaved fiber conductor.

11. A terminal connector as claimed in claim 10 wherein said terminal connector includes an engaging cavity for each ferrule that secures the ferrule relative to one of the LED transmitter and the photodiode.
